(19) United States
(12) Patent Application Publication
(10) Pub. No.: US 2025/0111170 A1
(43) Pub. Date: Apr. 3, 2025

(54) SYSTEM FOR CLIENT ONBOARDING AND EXPOSURE DETECTION USING LARGE LANGUAGE MODELS FOR COMPUTATIONAL EFFICIENCY

(71) Applicant: BANK OF AMERICA CORPORATION, Charlotte, NC (US)

(72) Inventors: Chandra S. Adavi, Alpharetta, GA (US); Michael J. Oberle, Waxhaw, NC (US)

(73) Assignee: BANK OF AMERICA CORPORATION, Charlotte, NC (US)

(21) Appl. No.: 18/376,342

(22) Filed: Oct. 3, 2023

(51) Int. Cl. G06F 40/47; G06F 40/20

(52) U.S. Cl. CPC G06F 40/47; G06F 40/20

(57) ABSTRACT

Systems, computer program products, and methods are described herein for client onboarding and exposure detection using large language models (LLMs) for computational efficiency. The present disclosure is configured to receive interaction data associated with a first user and a second user, wherein the interaction data is associated with an onboarding process for the second user; determine, using a behavioral analysis large language model (LLM) module, an interaction response pattern of the second user from the interaction data; determine interaction response times of the second user from the interaction data; compare the interaction response pattern and the interaction response times with past interactions known to be associated with misappropriate activity; determine a likelihood associated with whether the second user is associated with misappropriate activity based on at least the comparison; and execute a mitigation action in an instance in which the likelihood meets a misappropriate threshold.

### TECHNOLOGICAL FIELD

Example embodiments of the present disclosure relate to client onboarding and exposure detection using large language models (LLMs) for computational efficiency.

### BACKGROUND

The process of onboarding new clients is often a complex and resource-intensive procedure for organizations. This complexity stems from numerous sources such as the need for effective communication, particularly with clients unfamiliar with industry-specific jargon, the necessity to scrutinize each client for potential exposure or misrepresentation, or the like. Misunderstandings or miscommunication during this process can lead to errors which in turn necessitate the expenditure of additional computational resources for rectification. Furthermore, traditional methods of detecting exposure can be time-consuming, often requiring manual scrutiny and decision-making that increases the chances of errors and missed detection.

Applicant has identified a number of deficiencies and problems associated with client onboarding and exposure detection. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for client onboarding and exposure detection using large language models (LLMs) for computational efficiency.

In one aspect, a system for client onboarding and exposure detection using large language models (LLMs) for computational efficiency is presented. The system comprising: a processing device; a non-transitory storage device containing instructions when executed by the processing device, causes the processing device to: receive interaction data associated with a first user and a second user, wherein the interaction data is associated with an onboarding process for the second user; determine, using a behavioral analysis large language model (LLM) module, an interaction response pattern of the second user from the interaction data; determine interaction response times of the second user from the interaction data; compare the interaction response pattern and the interaction response times with past interactions known to be associated with misappropriate activity; determine a likelihood associated with whether the second user is associated with misappropriate activity based on at least the comparison; and execute a mitigation action in an instance in which the likelihood meets a misappropriate threshold.

In some embodiments, executing the instructions further causes the processing device to: translate, using an LLM-based jargon translation module, industry-specific terms in the interaction data into layperson-friendly language.

In some embodiments, executing the instructions further causes the processing device to: retrieve, from a database, the past interactions known to be associated with misappropriate activity; determine that the likelihood associated with whether the second user is associated with misappropriate activity meets the misappropriate threshold; and update the database with the interaction data.

In some embodiments, executing the instructions further causes the processing device to: determine the likelihood associated with whether the second user is associated with misappropriate activity based on at least a geographic location of the second user, device information associated with the second user, and previous interaction history of the second user.

In some embodiments, executing the instructions further causes the processing device to: assign weights to the interaction response pattern, the interaction response times, the geographic location of the second user, the device information associated with the second user, and previous interaction history of the second user; and determine, using a weighted algorithm, the likelihood associated with whether the second user is associated with misappropriate activity based on at least the one or more weights.

In some embodiments, executing the instructions further causes the processing device to: analyze, using the behavioral analysis LLM module, a complexity of the interaction response pattern of the second user based on at least linguistic elements of the interaction response pattern, wherein the linguistic elements comprise at least vocabulary usage, sentence structure, and coherence; and update the likelihood associated with whether the second user is associated with misappropriate activity based on at least the complexity.

In some embodiments, the behavioral analysis LLM module is trained in a domain relevant to the onboarding process, enhancing an accuracy of the comparison against past interactions known to be associated with misappropriate activity.

In some embodiments, executing the instructions further causes the processing device to: adapt a level of scrutiny of the interaction data by dynamically adjusting one or more parameters for the interaction response pattern and one or more parameters for analysis of the interaction response time, thereby optimizing computational resources without compromising accuracy of misappropriate activity detection.

In some embodiments, the mitigation action is executed in real-time upon determining that the likelihood meets the misappropriate threshold.

In another aspect, a computer program product for client onboarding and exposure detection using large language models (LLMs) for computational efficiency is presented. The computer program product comprising a non-transitory computer-readable medium comprising code configured to cause an apparatus to: receive interaction data associated with a first user and a second user, wherein the interaction data is associated with an onboarding process for the second user; determine, using a behavioral analysis large language model (LLM) module, an interaction response pattern of the second user from the interaction data; determine interaction response times of the second user from the interaction data; compare the interaction response pattern and the interaction response times with past interactions known to be associated with misappropriate activity; determine a likelihood associated with whether the second user is associated with misappropriate activity based on at least the comparison; and execute a mitigation action in an instance in which the likelihood meets a misappropriate threshold.

In yet another aspect, a method for client onboarding and exposure detection using large language models (LLMs) for computational efficiency is presented. The method comprising: receiving interaction data associated with a first user and a second user, wherein the interaction data is associated with an onboarding process for the second user; determining, using a behavioral analysis large language model (LLM) module, an interaction response pattern of the second user from the interaction data; determining interaction response times of the second user from the interaction data; comparing the interaction response pattern and the interaction response times with past interactions known to be associated with misappropriate activity; determining a likelihood associated with whether the second user is associated with misappropriate activity based on at least the comparison; and executing a mitigation action in an instance in which the likelihood meets a misappropriate threshold.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for client onboarding and exposure detection using large language models (LLMs) for computational efficiency, in accordance with an embodiment of the disclosure;

FIG. 2 illustrates a process flow for client onboarding and exposure detection using large language models (LLMs) for computational efficiency, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “module” may refer to a distinct functional unit within a system, designed to perform a specific function or set of functions. In various embodiments, a module may comprise both hardware and software components that work in concert to achieve the designated tasks. For example, in some embodiments, a “module” may include processing circuitry, algorithms, routines, storage media, network interfaces, input/output mechanisms, and the like. In some embodiments, each module may include one or more units, each designed to perform a specific function or set of functions within the broader scope of the module's objectives. These units may utilize the processing circuitry, algorithms, routines, storage media, network interfaces, and input/output mechanisms associated with the module to execute their designated tasks. In some embodiments, modules may operate independently or in conjunction with other modules to achieve system-wide objectives. In some cases, similar or common hardware may be shared across multiple modules, obviating the need for duplicate hardware. For example, the same processor could be used in both a behavior analysis LLM module and an LLM-based translation module. Components of a module may be housed together or separately, depending on system architecture and functional requirements.

As described in more detail herein, the behavioral analysis LLM module serves as an illustrative example of a module comprising multiple specialized units. Initially, a data pre-processing unit is responsible for cleaning the incoming interaction data, removing outliers and other irrelevant or erroneous data points. The data pre-processing unit may employ algorithms and processing circuitry for this purpose. A data normalization unit within the module may then standardizes the interaction data to ensure consistency across various data points. Following normalization, a feature extraction unit may identify key variables or attributes that are most relevant for determining the second user's interaction response pattern.

The feature extraction unit may also apply data transformation techniques, such as dimensionality reduction, to simplify the dataset. A tokenization unit may then segment the pre-processed data into smaller units, serving as input for the neural network layers managed by a neural network processing unit. This neural network processing unit utilizes multiple interconnected layers of nodes to understand the semantic and contextual nuances of the data. A pattern recognition unit employs machine learning algorithms with attention mechanisms to focus on specific portions of the data for pattern recognition. Additionally, a statistical analysis unit may apply statistical methods to identify trends within the interaction data. Finally, a post-analysis compilation unit compiles the identified patterns and trends into a comprehensive interaction response portfolio for the second user. This unit may use storage media to temporarily hold the results and network interfaces to communicate these results to other components within the system.

The process of onboarding new clients is often a complex and resource-intensive procedure for organizations. This complexity stems from numerous sources such as the need for effective communication, particularly with clients unfamiliar with industry-specific jargon, the necessity to scrutinize each client for potential exposure or misrepresentation, or the like. Misunderstandings or miscommunication during this process can lead to errors which in turn necessitate the expenditure of additional computational resources for rectification. Furthermore, traditional methods of detecting exposure can be time-consuming, often requiring manual scrutiny and decision-making that increases the chances of errors and missed detection.

Embodiments of the invention are directed towards a Large Language Models (LLMs) based onboarding system capable of enhancing the onboarding process of a new client in an entity, reducing errors, and saving valuable computational resources. The system may be used to interpret and translate complex industry-specific terms, such as “mortgage,” into layperson-friendly language, ensuring clear and effective communication, and consequently minimizing misunderstandings. Such a targeted use of LLMs solves a specific and pervasive problem in client onboarding processes, thereby reducing human error and streamlining computational processes. Fewer cycles are spent rectifying errors or misunderstandings, which results in significant time and resource savings.

In addition, the system may identify misappropriate activities during the onboarding process by scrutinizing response times and patterns to each question and analyzing them against a large database of known behaviors and past interactions. Such complex analyses would be computationally costly and time-consuming if done manually or using conventional methods. However, an LLM-based system, with its pattern recognition capabilities, can accomplish this with fewer computational resources. Such a technical improvement enhances both the efficiency and security of the client onboarding process. Furthermore, the technical solution described herein uses a rigorous, computerized process to perform specific tasks and/or activities that were not previously performed. In specific implementations, the technical solution bypasses a series of steps previously implemented, thus further conserving computing resources.

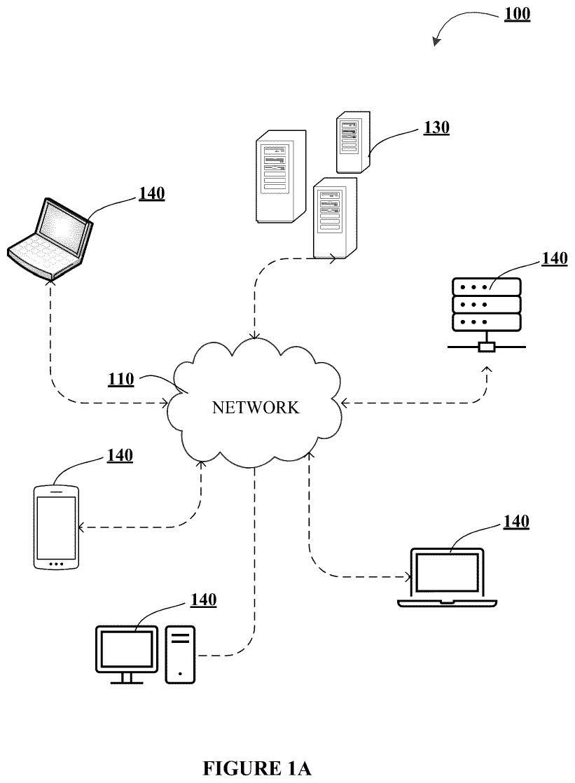

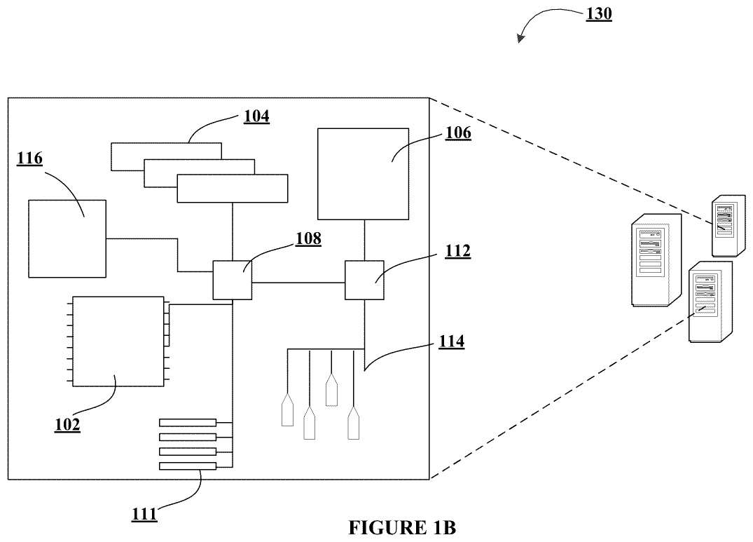

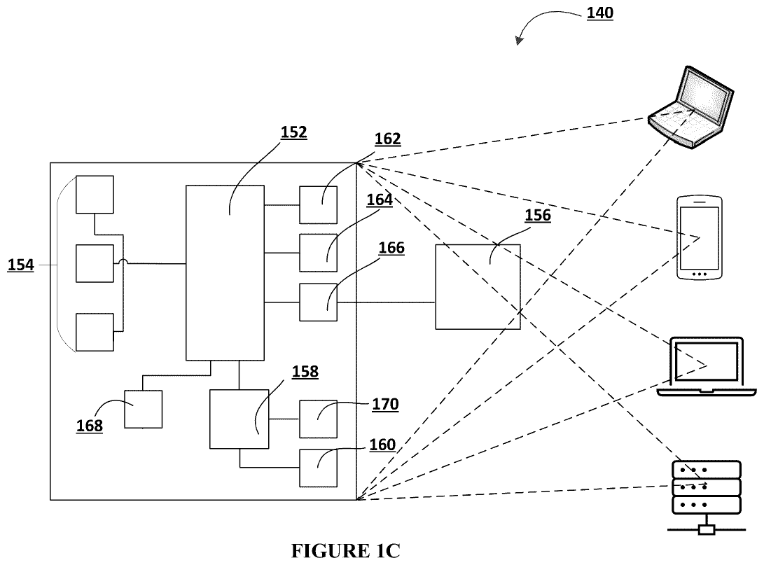

FIGS. 1A-1C illustrate technical components of an exemplary distributed computing environment for client onboarding and exposure detection using large language models (LLMs) for computational efficiency 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

In some embodiments, the system 130 may include employ multiple specialized modules, each designed to perform specific functions in the client onboarding and exposure detection processes. These modules may include, but are not limited to, a behavioral analysis LLM module for interaction pattern recognition, an LLM-based jargon translation module for industry-specific term translation, an LLM-based language translation module for overcoming language barriers, and/or the like. Each module may be a self-contained component capable of executing specialized processes and may interact with other modules or subsystems within the system to achieve the desired outcomes. These modules may leverage the computational capabilities of the processor 102 and may store or retrieve data from the memory 104 or the storage device 106. The high-speed interface 108 and low-speed interface 112 facilitate data exchange between these modules and the system's hardware components, ensuring efficient operation. By employing multiple specialized modules, the system 130 can execute complex process flows with enhanced computational efficiency and accuracy. This modular approach allows for greater flexibility and scalability, enabling the system to adapt to varying operational requirements and to integrate new functionalities as needed.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

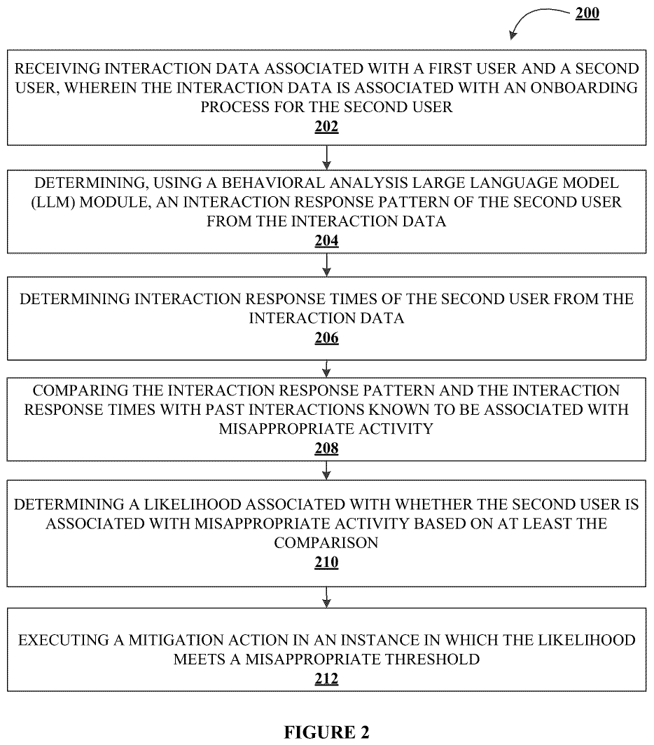

FIG. 2 illustrates a process flow 200 for client onboarding and exposure detection using large language models (LLMs) for computational efficiency, in accordance with an embodiment of the disclosure. As shown in block 202, the process flow includes receiving interaction data associated with a first user and a second user, wherein the interaction data is associated with an onboarding process for the second user. In some embodiments, the first user typically represents an entity or individual responsible for managing the onboarding process, such as an organization or an employee thereof. The second user is the client or individual undergoing the onboarding process.

In some embodiments, the interaction data may comprise various forms of digital information, including but not limited to text, voice recordings, clickstreams, and form submissions. The interaction data may be collected through multiple channels, such as web interfaces, mobile applications, or voice-activated systems, and is transmitted to a centralized data repository. In some embodiments, the interaction data may then be stored in a secure database, where it is indexed and made queryable for future operations. Access controls and encryption methods may be applied to safeguard the integrity and confidentiality of the stored data. In specific embodiments, in parallel, metadata associated with the interaction data may be generated and stored. This metadata may include timestamps, user identifiers, and other contextual information that aids in the accurate interpretation and processing of the interaction data. The stored interaction data is subsequently made available to various modules within the system, and may serve as the input for multiple computational processes aimed at enhancing the efficiency and effectiveness of the onboarding process for the second user.

As shown in block 204, the process flow includes determining, using a behavioral analysis large language model (LLM) module, an interaction response pattern of the second user from the interaction data.

In some embodiments, the interaction data may include industry-specific jargon. For example, in the financial industry, when onboarding clients, depending on the type of client being onboarded, they may be introduced to terms such as collective investment, balance sheet, cash equivalents, interest bearing notes, and/or the like. Recognizing the potential for misunderstandings due to these specialized terms, the system may incorporate an LLM-based jargon translation module. The LLM-based jargon translation module may employ a jargon identification unit that may identify instances of industry-specific jargon. This may be accomplished through a series of algorithms that scan the data against a predefined lexicon of industry terms. The lexicon may be regularly updated to ensure its relevance and accuracy. Once the industry-specific terms are identified, they are isolated for translation.

Once the industry-specific terms are identified, they may be isolated for translation by a term tokenization unit. The term tokenization unit may break down the terms into smaller units, or tokens, facilitating easier processing. These tokens may then be fed into a translation processing unit within the LLM-based jargon translation module. The term tokenization unit may be specifically trained on a corpus of industry literature and layperson-friendly explanations, and may employs machine learning algorithms run on processing circuitry to generate layperson-friendly equivalents of the identified jargon. For example, the term “collective investment” may be translated to “a group of investments that are managed together,” and “balance sheet” to “a financial statement that shows a company's information, and equity.”

Upon successful translation, a post-processing integration unit may re-integrate the translated terms back into the original interaction data. This post-processing integration unit may ensure that the overall context and meaning of the interaction are preserved while making the data more accessible to individuals lacking specialized industry knowledge. The system may then present this layperson-friendly interaction data to the second user, thereby enhancing communication clarity during the onboarding process. This technical feature not only improves user experience but also minimizes the chances of misunderstandings that could lead to errors or delays in the onboarding process.

In specific embodiments, the second user may opt for communication in a particular language, creating a language barrier with the first user. For example, the second user might be more at ease communicating in Spanish. To mitigate this challenge, the system incorporates an LLM-based language translation module designed to facilitate effective communication between the two parties. Upon receiving the interaction data, in some embodiments, the system may employ a language detection unit to identify any language translation requirement based on the second user's language preference. Algorithms within the language detection unit may detect the language of the incoming interaction data and ascertain whether it aligns with the second user's preferred language. If a translation is deemed necessary, the interaction data is directed to the LLM-based language translation module. The LLM-based language translation module may be trained on extensive bilingual or multilingual datasets to ensure accurate and contextually appropriate translations.

In some embodiments, the LLM-based language translation module may tokenize the interaction data, i.e., segmenting the interaction data into smaller units, such as words or phrases using a tokenization unit, which are then used as input for the LLM-based language translation module's neural network layers. Then, using machine learning algorithms and attention mechanisms, the LLM-based language translation module may comprehend the semantic and contextual aspects of each token in the source language. Upon comprehension, the LLM-based language translation module may employ a translation processing unit to generate corresponding tokens in the target language, maintaining the integrity of the original message. In some embodiments, the LLM-based language translation module may include a post-processing integration unit that may be configured for reassembling the translated tokens into a coherent text or voice output. This output is subsequently encoded and presented to the second user in their language of preference.

In some embodiments, the behavioral analysis LLM module may be trained in a domain that is directly relevant to the onboarding process. For example, if the system is employed within the financial industry, the LLM may be trained on a corpus of financial literature, historical financial interactions, and flagged cases of misappropriate activity specific to this industry. Such domain-specific training allows the LLM to be highly attuned to the nuances, jargon, and behavioral patterns that are characteristic of interactions within this particular field. The domain-specific training enhances the accuracy of the comparison against past interactions known to be associated with misappropriate activity. By being trained in the relevant domain, the behavioral analysis LLM module may be better equipped to identify subtle indicators of misappropriate behavior that may be overlooked by a more generalized model. For instance, the behavioral analysis LLM module can more accurately weigh the significance of specific terms, response times, and interaction patterns that are known red flags within the domain. This results in a more precise and reliable assessment of the likelihood that the second user is associated with misappropriate activity, thereby improving the system's overall effectiveness in identifying and mitigating exposures.

In some embodiments, the behavioral analysis LLM module may include a data pre-processing unit configured to prepare the interaction data for analysis. The data pre-processing unit unit may use algorithms and processing circuitry to clean the interaction data, removing irrelevant or erroneous data points such as outliers or anomalies. Subsequently, a data normalization unit within the module may standardize the interaction data to ensure consistency. For instance, text data may be converted to lowercase, and timestamps may be standardized to a single time zone. Following normalization, a feature extraction unit may identify key variables or attributes within the interaction data that are most relevant for determining the second user's interaction response pattern. In some embodiments, the feature extraction unit may also apply data transformation techniques, such as dimensionality reduction, to simplify the dataset without losing critical information.

In some embodiments, to determine the interaction response pattern, the behavioral analysis LLM module may include a tokenization unit that segments the pre-processed interaction data into smaller units, such as words or phrases. These tokens may serve as input for the module's neural network layers, which may be managed by a neural network processing unit. The tokenization unit may be composed of multiple interconnected layers of nodes, each designed to perform specific functions. For example, the input layer may receive the tokens, and through a series of hidden layers, the data undergoes transformations that allow the model to understand its semantic and contextual nuances.

Additionally, in some embodiments, a pattern recognition unit within the behavioral analysis LLM module may employ machine learning algorithms equipped with attention mechanisms. The pattern recognition unit may focus on specific portions of the interaction data that are most relevant for pattern recognition. Statistical methods may also be applied by a statistical analysis unit to identify trends within the interaction data. For example, time-series analysis may be used to detect recurring behaviors or preferences exhibited by the second user. Once the analysis is complete, a post-analysis compilation unit may compile the identified patterns and trends into a comprehensive interaction response portfolio for the second user.

As shown in block 206, the process flow includes determining interaction response times of the second user from the interaction data. In some embodiments, the behavioral analysis LLM module may isolate the timestamps associated with each interaction event and serve as the primary input for the analysis of response times. These isolated timestamps may then be subjected to a series of computational processes to calculate the time intervals between successive interaction events. In one aspect, such calculations may employ statistical methods to ensure accuracy and may also account for variables such as network latency or system delays. In some embodiments, the behavioral analysis LLM module may include one or more machine learning algorithms that may be used to analyze these calculated time intervals to identify patterns or trends. For example, the machine learning algorithms could determine whether the second user typically responds more quickly to certain types of queries or during specific phases of the onboarding process. In example embodiments, the behavioral analysis LLM module may include anomaly detection models that may be used to identify any irregularities in the response times. For instance, unusually long or short response times could be flagged for further investigation as they may indicate potential issues such as user disengagement or automated bot activity. Once the analysis is complete, the determined interaction response times may be compiled into a portfolio for the second user. This portfolio can be integrated with other behavioral data to provide a comprehensive understanding of the second user's interaction patterns. The capabilities of this component in analyzing interaction response times not only contribute to a more accurate understanding of the second user's behavior but also optimize the efficiency of the onboarding process by enabling targeted interventions based on response time patterns.

In some embodiments, the system may adapt the level of scrutiny applied to the interaction data by dynamically adjusting one or more parameters related to the analysis of the interaction response pattern and the interaction response time. Such dynamic adjustment aims to optimize computational resources without compromising the accuracy of misappropriate activity detection. For example, during periods of high system load or when dealing with a large volume of interaction data, the system may choose to adjust the granularity of the analysis. It may reduce the number of features or variables considered in the interaction response pattern or may employ less computationally-intensive algorithms for time analysis. These adjustments are made dynamically, based on real-time assessments of system performance and computational load. That said, the system may maintain a high level of accuracy in detecting misappropriate activity by employing a set of core parameters that are critical for accurate detection and that remain constant, even when other parameters are adjusted. For instance, certain key indicators of misappropriate activity, such as specific red-flag terms or highly irregular response times, will always be included in the analysis irrespective of the level of computational optimization.

As shown in block 208, the process flow includes comparing the interaction response pattern and the interaction response times with past interactions known to be associated with misappropriate activity. In some embodiments, the system may the system retrieve the second user's interaction response pattern and interaction response times, which have been previously determined by other components within the system, and may serve as the primary data sets for comparison. Concurrently, the system may access a secure database containing records of past interactions that have been flagged for misappropriate activity. In some embodiments, these records may include various metrics such as abnormal response times, irregular patterns in interaction, or known indicators of unauthorized behavior. In some embodiments, the system may employ machine learning algorithms to perform the comparison. These algorithms may utilize techniques such as clustering, classification, or anomaly detection to assess the degree of similarity between the second user's interaction data and the flagged records in the database. In example embodiments, statistical methods may also be applied to quantify the likelihood that the second user's interaction behavior aligns with known patterns of misappropriate activity.

As shown in block 210, the process flow includes determining a likelihood associated with whether the second user is associated with misappropriate activity based on at least the comparison. In some embodiments, the system may assign weights to various factors, including the interaction response pattern, the interaction response times, the geographic location of the second user, device information associated with the second user, and previous interaction history of the second user. These weights may be predefined or dynamically adjusted based on the specific context or user's exposure portfolio.

After assigning weights, in some embodiments, the system may validate the comparison data to ensure it is accurate and free from anomalies that could skew the results. Following validation, the system may apply a weighted algorithm to the comparison data and the assigned weights. The weighted algorithm may use probabilistic models, such as Bayesian inference or logistic regression, to calculate the likelihood that the second user's behavior aligns with known patterns of misappropriate activity. The weighted algorithm takes into account the assigned weights for each factor, thereby providing a more nuanced and context-sensitive assessment of the likelihood that the second user is associated with misappropriate activity.

Additionally, in some embodiments, the system may analyze, using the behavioral analysis LLM module, a complexity of the interaction response pattern of the second user based on at least linguistic elements of the interaction response pattern, which may include vocabulary usage, sentence structure, and coherence. Subsequently, the system may update the likelihood associated with whether the second user is associated with misappropriate activity based on at least the complexity of the interaction response pattern.

As shown in block 212, the process flow includes executing a mitigation action in an instance in which the likelihood meets a misappropriate threshold. In some embodiments, the system may compare the calculated likelihood against the misappropriate threshold. If the likelihood exceeds this threshold, the system may execute the mitigation action (in real-time), thereby initiating further investigation or preventive measures. In some embodiments, the mitigation action may range from sending alerts to relevant parties, locking the second user's account, or initiating a more in-depth investigation.

In some embodiments, once the mitigation action is executed, the system may log the details of the action, the associated likelihood, and any other relevant data. Subsequently, the system may update the database with the new interaction data for future reference and analysis.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for client onboarding and exposure detection using large language models (LLMs) for computational efficiency, the system comprising:
a processing device;
a non-transitory storage device containing instructions when executed by the processing device, causes the processing device to:
receive interaction data associated with a first user and a second user, wherein the interaction data is associated with an onboarding process for the second user;
determine, using a behavioral analysis large language model (LLM) module, an interaction response pattern of the second user from the interaction data;
determine interaction response times of the second user from the interaction data;
compare the interaction response pattern and the interaction response times with past interactions known to be associated with misappropriate activity;
determine a likelihood associated with whether the second user is associated with misappropriate activity based on at least the comparison; and
execute a mitigation action in an instance in which the likelihood meets a misappropriate threshold.

2. The system of claim 1, wherein executing the instructions further causes the processing device to:
translate, using an LLM-based jargon translation module, industry-specific terms in the interaction data into layperson-friendly language.

3. The system of claim 1, wherein executing the instructions further causes the processing device to:
retrieve, from a database, the past interactions known to be associated with misappropriate activity;
determine that the likelihood associated with whether the second user is associated with misappropriate activity meets the misappropriate threshold; and
update the database with the interaction data.

4. The system of claim 1, wherein executing the instructions further causes the processing device to:
determine the likelihood associated with whether the second user is associated with misappropriate activity based on at least a geographic location of the second user, device information associated with the second user, and previous interaction history of the second user.

5. The system of claim 4, wherein executing the instructions further causes the processing device to:
assign weights to the interaction response pattern, the interaction response times, the geographic location of the second user, the device information associated with the second user, and previous interaction history of the second user; and
determine, using a weighted algorithm, the likelihood associated with whether the second user is associated with misappropriate activity based on at least the one or more weights.

6. The system of claim 1, wherein executing the instructions further causes the processing device to:
analyze, using the behavioral analysis LLM module, a complexity of the interaction response pattern of the second user based on at least linguistic elements of the interaction response pattern, wherein the linguistic elements comprise at least vocabulary usage, sentence structure, and coherence; and
update the likelihood associated with whether the second user is associated with misappropriate activity based on at least the complexity.

7. The system of claim 1, wherein the behavioral analysis LLM module is trained in a domain relevant to the onboarding process, enhancing an accuracy of the comparison against past interactions known to be associated with misappropriate activity.

8. The system of claim 1, wherein executing the instructions further causes the processing device to:
adapt a level of scrutiny of the interaction data by dynamically adjusting one or more parameters for the interaction response pattern and one or more parameters for analysis of the interaction response time, thereby optimizing computational resources without compromising accuracy of misappropriate activity detection.

9. The system of claim 8, wherein the mitigation action is executed in real-time upon determining that the likelihood meets the misappropriate threshold.

10. A computer program product for client onboarding and exposure detection using large language models (LLMs) for computational efficiency, the computer program product comprising a non-transitory computer-readable medium comprising code configured to cause an apparatus to:
receive interaction data associated with a first user and a second user, wherein the interaction data is associated with an onboarding process for the second user;
determine, using a behavioral analysis large language model (LLM) module, an interaction response pattern of the second user from the interaction data;
determine interaction response times of the second user from the interaction data;
compare the interaction response pattern and the interaction response times with past interactions known to be associated with misappropriate activity;
determine a likelihood associated with whether the second user is associated with misappropriate activity based on at least the comparison; and
execute a mitigation action in an instance in which the likelihood meets a misappropriate threshold.

11. The computer program product of claim 10, wherein the code further causes the apparatus to:
translate, using an LLM-based jargon translation module, industry-specific terms in the interaction data into layperson-friendly language.

12. The computer program product of claim 10, wherein the code further causes the apparatus to:
retrieve, from a database, the past interactions known to be associated with misappropriate activity;
determine that the likelihood associated with whether the second user is associated with misappropriate activity meets the misappropriate threshold; and
update the database with the interaction data.

13. The computer program product of claim 10, wherein the code further causes the apparatus to:
determine the likelihood associated with whether the second user is associated with misappropriate activity based on at least a geographic location of the second user, device information associated with the second user, and previous interaction history of the second user.

14. The computer program product of claim 13, wherein the code further causes the apparatus to:
assign weights to the interaction response pattern, the interaction response times, the geographic location of the second user, the device information associated with the second user, and previous interaction history of the second user; and
determine, using a weighted algorithm, the likelihood associated with whether the second user is associated with misappropriate activity based on at least the one or more weights.

15. The computer program product of claim 10, wherein the code further causes the apparatus to:
analyze, using the behavioral analysis LLM module, a complexity of the interaction response pattern of the second user based on at least linguistic elements of the interaction response pattern, wherein the linguistic elements comprise at least vocabulary usage, sentence structure, and coherence; and
update the likelihood associated with whether the second user is associated with misappropriate activity based on at least the complexity.

16. The computer program product of claim 10, wherein the behavioral analysis LLM module is trained in a domain relevant to the onboarding process, enhancing an accuracy of the comparison against past interactions known to be associated with misappropriate activity.

17. The computer program product of claim 10, wherein the code further causes the apparatus to:
adapt a level of scrutiny of the interaction data by dynamically adjusting one or more parameters for the interaction response pattern and one or more parameters for analysis of the interaction response time, thereby optimizing computational resources without compromising accuracy of misappropriate activity detection.

18. The computer program product of claim 17, wherein the mitigation action is executed in real-time upon determining that the likelihood meets the misappropriate threshold.

19. A method for client onboarding and exposure detection using large language models (LLMs) for computational efficiency, the method comprising:
receiving interaction data associated with a first user and a second user, wherein the interaction data is associated with an onboarding process for the second user;
determining, using a behavioral analysis large language model (LLM) module, an interaction response pattern of the second user from the interaction data;
determining interaction response times of the second user from the interaction data;
comparing the interaction response pattern and the interaction response times with past interactions known to be associated with misappropriate activity;
determining a likelihood associated with whether the second user is associated with misappropriate activity based on at least the comparison; and
executing a mitigation action in an instance in which the likelihood meets a misappropriate threshold.

20. The method of claim 19, wherein the method further comprises:
translating, using an LLM-based jargon translation module, industry-specific terms in the interaction data into layperson-friendly language.
